(19) United States
(12) Patent Application Publication
(10) Pub. No.: US 2012/0107727 A1
(43) Pub. Date: May 3, 2012

(54) FUEL CELL MODULE AND MANUFACTURING METHOD OF THE SAME

(76) Inventors: Jan-Dee Kim, Yongin-si (KR); Jun-Won Suh, Yongin-si (KR); Ho-Jin Kweon, Yongin-si (KR)

(21) Appl. No.: 13/222,787

(22) Filed: Aug. 31, 2011

(30) Foreign Application Priority Data
Nov. 3, 2010 (KR) 10-2010-0108622

(51) Int. Cl. H01M 4/86; B32B 38/08; H01M 4/88

(52) U.S. Cl. 429/523; 156/324

(57) ABSTRACT

A fuel cell module and a method of manufacturing the same. A fuel cell module including a unit cell in which a first electrode layer, an electrolyte layer, and a second electrode layer are sequentially laminated, wherein one of the first electrode layer and the second electrode layer includes a first region coated with a first electrode material layer having a first ionic conductivity, a second region coated with a second electrode material layer having a second ionic conductivity, and a third region coated with a third electrode material layer having a third ionic conductivity, and a method of manufacturing the same are provided. A temperature gradient difference of a unit cell is reduced so that more uniform performance of the unit cell may be achieved. The fuel cell module may be driven at low temperature and durability thereof may be improved.

### CROSS-REFERENCE TO RELATED APPLICATION

This application claims priority to and the benefit of Korean Patent Application No. 10-2010-0108622, filed on Nov. 3, 2010, in the Korean Intellectual Property Office, the entire content of which is incorporated herein by reference.

### BACKGROUND

1. Field

One or more embodiments of the present invention relate to a fuel cell module and a method of manufacturing the same, and more particularly, to a fuel cell module having a combination electrode and a method of manufacturing the same.

2. Description of Related Art

A fuel cell is a high efficiency clean power generating technology for directly converting hydrogen contained in hydrocarbon material such as natural gas, coal gas, methanol, etc. and oxygen in air into electric energy by an electro-chemical reaction. Fuel cells are roughly classified into an alkaline fuel cell, a phosphoric acid fuel cell, a molten carbonate fuel cell, a solid oxide fuel cell, and a polymer electrolyte membrane fuel cell, according to the kind of electrolyte used.

Among them, the solid oxide fuel cell is activated at high temperature from about 600 degrees Celsius to 1,000 degrees Celsius, and has the advantages of being among the most effective and least pollutive of the several types of existing fuel cells. In addition, solid oxide fuel cells have the advantage of not needing fuel from a reformer, and of enabling hybrid generation.

When a unit cell is extended in the horizontal direction, in the solid oxide fuel cell, there is a large temperature gradient from about 50 degrees Celsius to 150 degrees Celsius. Since the material of a cathode employed in the solid oxide fuel cell exhibits different ionic conductivities according to temperature, electrical performance at both ends of the unit cell is inferior and there is a performance difference within a single unit cell. In addition, running the fuel cell at high temperature causes the material of the fuel cell to rapidly deteriorate and the performance difference within the unit cell diminishes the durability of the fuel cell.

### SUMMARY

Accordingly, aspects of embodiments of the present invention are directed toward a fuel cell module having combination electrodes with multiple ionic conductivities and a method of manufacturing the same.

In addition, aspects of embodiments of the present invention are directed toward a fuel cell module having improved durability by making performance of unit cells more uniform and a method of manufacturing the same.

In order to achieve the foregoing and/or other aspects of the present invention, embodiments of the present invention include a fuel cell module including a unit cell in which a first electrode layer, an electrolyte layer, and a second electrode layer, the first electrode layer, the electrolyte layer, and the second electrode layer being sequentially laminated with one another, wherein at least one of the first electrode layer and the second electrode layer has a first region coated with a first electrode material layer having a first ionic conductivity, a second region coated with a second electrode material layer having a second ionic conductivity, and a third region coated with a third electrode material layer having a third ionic conductivity.

In certain embodiments, the second region is located adjacent to a side of the unit cell through which a fuel is injected, the third region is located adjacent to a side of the unit cell through which the fuel is discharged, and the first region is located between the second region and the third region.

When the first region, the second region, and the third region have a same temperature, the second ionic conductivity and the third ionic conductivity may be higher than the first ionic conductivity.

In certain embodiments, the second ionic conductivity is equal to the third ionic conductivity.

In addition, the second region may have the same area as that of the third region.

In this case, an area ratio of the second region to the first region may be 3:5 to 4:3.

Additionally, the second region may have the same area as that of the first region.

The first region, the second region, and the third region may have different areas respectively.

The area of the third region may be larger than that of the second region.

Meanwhile, the area of the first region may be larger than that of the second region.

The area of the second region may be larger than that of the first region.

In order to achieve another aspect of embodiments of the present invention, there is provided a method of manufacturing a fuel cell module, the method including: sequentially laminating a first electrode layer, an electrolyte layer, and a second electrode layer; and coating one of the first electrode layer or the second electrode layer to have a first region coated with a first electrode material layer having a first ionic conductivity, a second region coated with a second electrode material layer having a second ionic conductivity, and a third region coated with a third electrode material layer having a third ionic conductivity.

Here, the second region has a side at which a fuel is injected, the third region has a side at which the fuel is discharged, and the first region is between the second region and the third region.

When the first region, the second region, and the third region have a same temperature, the second ionic conductivity and the third ionic conductivity may be higher than the first ionic conductivity.

In this case, the second ionic conductivity may be equal to the third ionic conductivity.

The second region may have the same area as that of the third region.

In this case, an area ratio of the second region to the first region is 3:5 to 4:3.

The second region may have the same area as that of the first region.

The first region, the second region, and the third region may have different areas respectively.

The area of the third region may be larger than that of the second region.

The area of the first region may be larger than that of the second region.

The area of the second region may be larger than that of the first region.

According to embodiments of the present invention, a fuel cell module having a combination electrode having multiple ionic conductivities and a method of manufacturing the same may be provided.

In addition, temperature gradients along a unit cell may be reduced to make performance of the unit cell more uniform so that durability of the fuel cell module may be improved.

Moreover, a fuel cell module workable at lower temperatures than existing operating temperatures, thereby improving unit cell performance, and a method of manufacturing the same may be provided.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a cross-sectional view illustrating configuration of a unit cell of a solid oxide fuel cell (SOFC) module according to an embodiment of the present invention;

FIG. 2 is a side view of a unit cell illustrating configuration of a surface of a cathode coated with a combination electrode material layer according to a first embodiment of the present invention;

FIG. 3 is a side view of a unit cell illustrating configuration of a surface of a cathode coated with a combination electrode material layer according to a second embodiment of the present invention;

FIG. 4 is a side view of a unit cell illustrating configuration of a surface of a cathode coated with a combination electrode material layer according to a third embodiment of the present invention;

FIG. 5 is a side view of a unit cell illustrating configuration of a surface of a cathode coated with a combination electrode material layer according to a fourth embodiment of the present invention;

FIG. 6 is a side view of a unit cell illustrating configuration of a surface of a cathode coated with a combination electrode material layer according to a fifth embodiment of the present invention; and

FIG. 7 is a side view of a unit cell illustrating configuration of a surface of a cathode coated with a combination electrode material layer according to a sixth embodiment of the present invention.

### DETAILED DESCRIPTION

In the following detailed description, only certain exemplary embodiments of the present invention are shown and described, by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements throughout the specification.

Since the present invention may be modified in various ways and have various embodiments, the present invention will be described in detail with reference to the drawings. However, it should be understood that the present invention is not limited to a specific embodiment but includes all changes and equivalent arrangements and substitutions included in the spirit and scope of the present invention. In the following description of the present invention, if the detailed description of the already known structure and operation may confuse the subject matter of the present invention, the detailed description thereof will not be provided.

Terms “first” and “second” may be used in describing various elements but the elements are not limited to the terms. The terms are used only to distinguish an element from other elements.

Terms used in the following description are to describe specific embodiments and are not intended to limit the present invention. The expression of the singular includes the plural meaning unless otherwise explicitly stated. It should be understood that the terms “comprising,” “having,” “including,” and “containing” are to indicate features, numbers, steps, operations, elements, parts, and/or combinations but not to exclude one or more features, numbers, steps, operations, elements, parts, and/or combinations or additional possibilities.

Hereinafter, the embodiments of the present invention will be described with reference to the accompanying drawings.

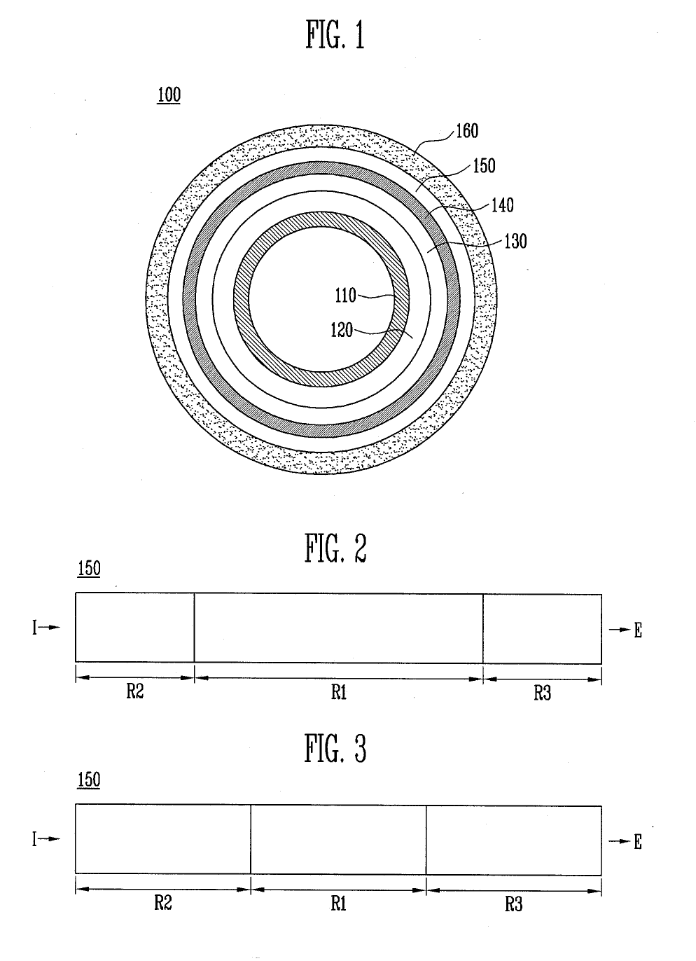

FIG. 1 is a cross-sectional view illustrating configuration of a unit cell of solid oxide fuel cell (SOFC) module according to an embodiment of the present invention. FIGS. 2 to 7 are side views of unit cells illustrating various configurations of a surface of a cathode coated with a combination electrode material layer according to various embodiments of the present invention.

Referring to FIG. 1, a solid oxide fuel cell (SOFC) module according to an embodiment of the present invention includes a cylindrical unit cell 100 in which a first electrode layer 130, an electrolyte layer 140, and a second electrode layer 150 are sequentially laminated with one another. When the first electrode layer 130 is an anode and the second electrode layer 150 is a cathode, the unit cell 100 generates electricity by reacting hydrogen supplied through the first electrode layer 130 as the anode and oxygen supplied through the second electrode layer 150 as the cathode by way of an electro-chemical reaction.

In addition, a first electrode current collector 120 is formed on the inner circumference of the first electrode layer 130 and a second electrode current collector 160 is formed on the outer circumference of the second electrode layer 150 such that electricity generated from the unit cell 100 is fed to an external device or an external circuit through the first electrode current collector 120 and a second electrode current collector 160.

In one embodiment, the second electrode current collector 160 is generally formed in the form of a spiral wire wound around the outer circumference of the second electrode layer 150.

Suitable metal materials such as a wire, a stick, a metal tube, and/or a tube as the first electrode current collector 120 may be inserted into (located on) the inner circumference of the first electrode layer 130, and as illustrated in FIG. 1, the first electrode current collector 120 may be fixed close to on) the inner circumference of the first electrode layer 130 by a metal tube 110 formed on the first electrode layer 130.

Suitable metal materials such as a wire, a stick, a pipe, and/or a tube collect current from the first electrode layer 130 and improve the strength of the fuel cell. In addition, a separate metal tube 110 may be located on the first electrode current collector 120 such that the first electrode current collector 120 may be fixed close to the inner surface of the first electrode layer 130 and the strength of the unit cell may be improved.

Hereinafter, a fuel cell module having a unit cell 100 in which the first electrode layer 130 is an anode and the second electrode layer 150 is a cathode will be described with reference to FIGS. 1 to 4.

Referring to FIGS. 1 and 2, the surface of the second electrode layer 150 according to the first embodiment of the present invention is coated with a combination electrode material layer.

On the surface of the second electrode layer 150, a first region R1, a second region R2 and a third region R3 are formed. Here, the first region R1 is coated with a first electrode material layer having a first ionic conductivity, the second region R2 is coated with a second electrode material layer having a second ionic conductivity, and the third region R3 is coated with a third electrode material layer having a third ionic conductivity. More specifically, the second region R2 is a set (or predetermined) region located adjacent to a side I of the unit cell, into which a fuel is injected, the third region R3 is a set (or predetermined) region located adjacent to a side E of the unit cell, through which the fuel is discharged, opposite to the second region R2, and the first region R1 is located between the second region R2 and the third region R3.

Here, the second and third ionic conductivities of the second region R2 and the third region R3 (i.e., the end regions of the second electrode layer 150) are higher than the ionic conductivity of the first region R1 (i.e., the central region of the second electrode layer 150), at the same temperature. That is, when the first region R1, the second region R2, and the third region R3 have the same temperature, the second ionic conductivity and the third ionic conductivity are higher than the first ionic conductivity. Meanwhile, when suitable, the second ionic conductivity of the second region R2 may be equal to the third ionic conductivity of the third region R3.

In the case of a unit cell 100 having a horizontally extended shape, a temperature gradient difference of about 50 degrees Celsius to 150 degrees Celsius may extend from the central region of the second electrode layer 150 to both ends of the second electrode layer 150. The electrode material layer forming the second electrode layer 150 may have an ionic conductivity that varies with temperature. Due to this variation in ionic conductivity, performance of the second region R2 and the third region R3 (i.e., the end regions), which are at relatively lower temperatures, may be inferior to the performance of the first region R1 (i.e., the central region), which is at a relatively higher temperature. That is, a performance difference may be generated within a single unit cell 100.

However, when the second region R2 and the third region R3 (i.e., the end regions), which are at relatively lower temperatures than that of the first region R1 (i.e., the high temperature central region), are coated with the second electrode material layer and the third electrode material layer having higher ionic conductivities at the same temperature, as for example in this embodiment of the present invention, the temperature gradient difference within the unit cell may be reduced. Thus, non-uniform performance of a fuel cell caused by a temperature gradient difference may be made more uniform.

In this embodiment of the present invention, the second region R2 has the same area as that of the third region R3. An area ratio of the second region R2 to the first region R1 may be 3:5 to 4:3, particularly, an area ratio of the first region R1 may be larger but the ratio is not limited to the area ratio of the second region R2 to the first region R1.

Referring to FIGS. 1 and 3, a surface of the second electrode layer 150 according to a second embodiment of the present invention is also coated with a combination electrode material layer.

On the surface of the second electrode layer 150, a first region R1, a second region R2, and a third region R3 are formed. Here, the first region R1 is coated with a first electrode material layer having a first ionic conductivity, the second region R2 is coated with a second electrode material layer having a second ionic conductivity, and the third region R3 is coated with a third electrode material layer having a third ionic conductivity. More specifically, the second region R2 is a set (or predetermined) region located adjacent to a side I of the unit cell, through which a fuel is injected, the third region R3 is a set (or predetermined) region located adjacent to a side E of the unit cell, through which the fuel is discharged, opposite to the second region R2, and the first region R1 is located between the second region R2 and the third region R3.

Here, the second and third ionic conductivities of the second region R2 and the second region R3 (i.e., the end regions of the second electrode layer 150) are higher than the ionic conductivity of the first region R1 (i.e., the central region of the second electrode layer 150), at the same temperature. That is, when the first region R1, the second region R2, and the third region R3 have the same temperature, the second ionic conductivity and the third ionic conductivity are higher than the first ionic conductivity. Meanwhile, when suitable, the second ionic conductivity of the second region R2 may be the same as (equal to) the third ionic conductivity of the third region R3.

In this embodiment of the present invention, unlike in the first embodiment of the present invention, the first region R1, the second region R2, and the third region R3 have the same area.

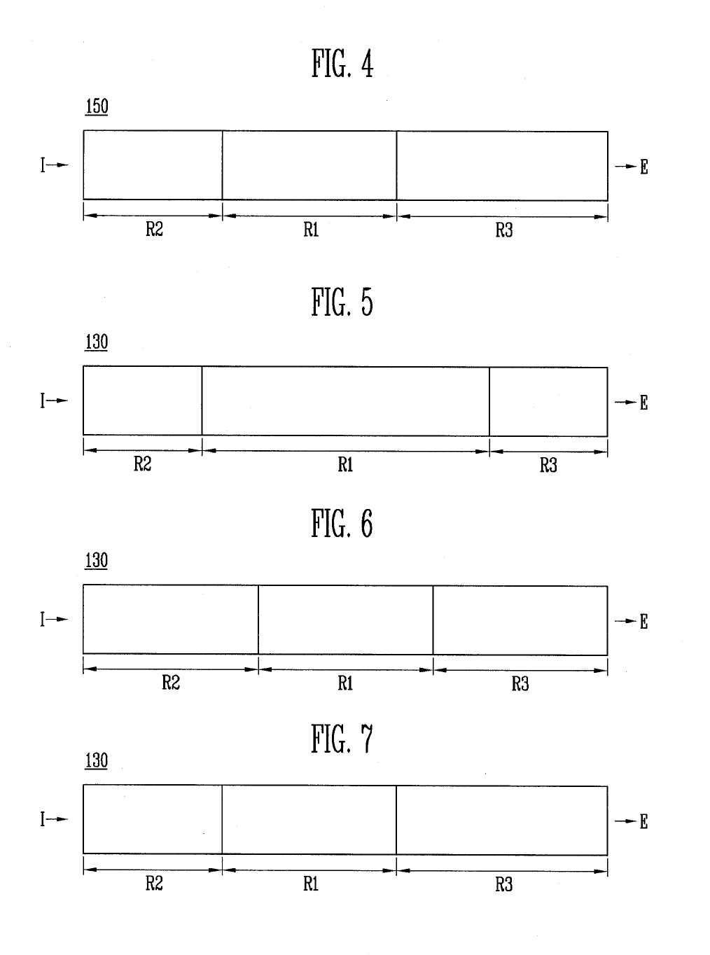

Referring to FIGS. 1 and 4, a surface of a second electrode layer 150 according to a third embodiment of the present invention is also coated with a combination electrode material layer.

On the surface of the second electrode layer 150, a first region R1, a second region R2, and a third region R3 are formed. Here, the first region R1 is coated with a first electrode material layer having a first ionic conductivity, the second region R2 is coated with a second electrode material layer having a second ionic conductivity, and the third region R3 is coated with a third electrode material layer having a third ionic conductivity. More specifically, the second region R2 is a set (or predetermined) region located adjacent to a side I of the unit cell, through which a fuel is injected, the third region R3 is a set (or predetermined) region located adjacent to a side E of the unit cell, through which the fuel is discharged, opposite to the second region R2, and the first region R1 is located between the second region R2 and the third region R3.

Here, the second and third ionic conductivities of the second region R2 and the second region R3 (i.e., the end regions of the second electrode layer 150) are higher than the ionic conductivity of the first region R1 (i.e., the central region of the second electrode layer 150), at the same temperature. That is, when the first region R1, the second region R2, and the third region R3 have the same temperature, the second ionic conductivity and the third ionic conductivity are higher than the first ionic conductivity. Meanwhile, when suitable, the second ionic conductivity of the second region R2 may be the same as (equal to) the third ionic conductivity of the third region R3.

In this embodiment of the present invention, unlike in the first embodiment and in the second embodiment of the present invention, the area of the second region R2 located at a side I of the unit cell, through which a fuel is injected is smaller than the area of the third region located at a side E of the unit cell, through which the fuel is discharged. In this case, the area of the second region R2 may be larger than the area of the first region R1, and the area of the first region R1 may be larger than the area of the second region R2. If a material layer having high ionic conductivity at low temperature is formed to have a large area and is located adjacent to a side of the unit cell having a large area of low temperature, the temperature gradient difference may be further reduced. Therefore, non-uniform performance of a fuel cell caused by the temperature gradient difference may be made more uniform.

Hereinafter, a fuel cell module including a unit cell 100 having a first electrode layer 130 as a cathode and a second electrode layer 150 as an anode will be described with reference to FIGS. 1 and 5 to 7.

Referring to FIGS. 1 and 5, the surface of the first electrode layer 130 according to a fourth embodiment of the present invention is coated with a combination electrode material layer.

On the surface of the first electrode layer 130, a first region R1, a second region R2, and a third region R3 are formed. Here, the first region R1 is coated with a first electrode material layer having a first ionic conductivity, the second region R2 is coated with a second electrode material layer having a second ionic conductivity, and the third region R3 is coated with a third electrode material layer having a third ionic conductivity. More specifically, the second region R2 is a set (or predetermined) region located adjacent to a side I of the unit cell, through which a fuel is injected, the third region R3 is a set (or predetermined) region located adjacent to a side E of the unit cell, through which the fuel is discharges, opposite to the second region R2, and the first region R1 is located between the second region R2 and the third region R3.

Here, the second and third ionic conductivities of the second region R2 and the second region R3 (i.e., the end regions of the first electrode layer 130) are higher than the ionic conductivity of the first region R1 (i.e., the central region of the first electrode layer 130), at the same temperature. That is, when the first region R1, the second region R2, and the third region R3 have the same temperature, the second ionic conductivity and the third ionic conductivity are higher than the first ionic conductivity. Meanwhile, when suitable, the second ionic conductivity of the second region R2 may be the same as (equal to) the third ionic conductivity of the third region R3.

In a case of a unit cell 100 having a horizontally extended shape, a temperature gradient difference of about 50 degrees Celsius to 150 degrees Celsius may extend from the central region of the first electrode layer 130 to both ends of the first electrode layer 130. The electrode material layer forming the first electrode layer 130 may have an ionic conductivity that varies with temperature. Due to this variation in ionic conductivity, performance of the second region R2 and the third region R3 (i.e., the end regions), which are at relatively lower temperatures, may be inferior to the performance of the first region R1 (i.e., the central region), which is at a relatively higher temperature. That is, a performance difference may be generated within a single unit cell 100.

However, like in this embodiment of the present invention, when the second region R2 and the third region R3 (i.e., the end regions), which are at relatively lower temperatures than that of the first region R1 (i.e., the high temperature central region), are coated with the second electrode material layer and the third electrode material layer having higher ionic conductivities at the same temperature, the temperature gradient difference within the unit cell may be reduced. Thus, non-uniform performance of a fuel cell caused by the temperature gradient difference may be made more uniform.

In this embodiment of the present invention, the second region R2 has the same area as that of the third region R3. An area ratio of the second region R2 to the first region R1 may be 3:5 to 4:3, particularly, an area ratio of the first region R1 may be larger but the ratio is not limited to the area ratio of the second region R2 to the first region R1.

Referring to FIGS. 1 and 6, a surface of the first electrode layer 130 according to a fifth embodiment of the present invention is also coated with a combination electrode material layer.

On the surface of the first electrode layer 130, a first region R1, a second region R2, and a third region R3 are formed. Here, the first region R1 is coated with a first electrode material layer having a first ionic conductivity, the second region R2 is coated with a second electrode material layer having a second ionic conductivity, and the third region R3 is coated with a third electrode material layer having a third ionic conductivity. More specifically, the second region R2 is a set (or predetermined) region located adjacent to a side I of the unit cell, through which a fuel is injected, the third region R3 is a set (or predetermined) region located adjacent to a side E of the unit cell, through which the fuel is discharged, opposite to the second region R2, and the first region R1 is located between the second region R2 and the third region R3.

Here, the second and third ionic conductivities of the second region R2 and the second region R3 (i.e., the end regions of the first electrode layer 130) are higher than the ionic conductivity of the first region R1 (i.e., the central region of the first electrode layer 130), at the same temperature. That is, when the first region R1, the second region R2, and the third region R3 have the same temperature, the second ionic conductivity and the third ionic conductivity are higher than the first ionic conductivity. Meanwhile, when suitable, the second ionic conductivity of the second region R2 may be the same as (equal to) the third ionic conductivity of the third region R3.

In this embodiment of the present invention, unlike in the fourth embodiment of the present invention, the first region R1, the second region R2, and the third region R3 have the same area.

Referring to FIGS. 1 and 7, a surface of the first electrode layer 130 according to a sixth embodiment of the present invention is also coated with a combination electrode material layer.

On the surface of the first electrode layer 130, a first region R1, a second region R2, and a third region R3 are formed. Here, the first region R1 is coated with a first electrode material layer having a first ionic conductivity, the second region R2 is coated with a second electrode material layer having a second ionic conductivity, and the third region R3 is coated with a third electrode material layer having a third ionic conductivity. More specifically, the second region R2 is a set (or predetermined) region located adjacent to a side I of the unit cell, through which a fuel is injected, the third region R3 is a set (or predetermined) region located adjacent to a side E of the unit cell, through which the fuel is discharged, opposite to the second region R2, and the first region R1 is located between the second region R2 and the third region R3.

Here, the second and third ionic conductivities of the second region R2 and the second region R3 (i.e., the end regions of the first electrode layer 130) are higher than the ionic conductivity of the first region R1 (i.e., the central region of the first electrode layer 130), at the same temperature. That is, when the first region R1, the second region R2, and the third region R3 have the same temperature, the second ionic conductivity and the third ionic conductivity are higher than the first ionic conductivity. Meanwhile, when suitable, the second ionic conductivity of the second region R2 may be equal to the third ionic conductivity of the third region R3.

In this embodiment of the present invention, unlike in the fourth and fifth embodiments of the present invention, the area of the second region R2 located adjacent to the side I of the unit cell, through which a fuel is injected, is smaller than the area of the third region R3 located adjacent to the side E of the unit cell, through which the fuel is discharged. In this case, the area of the second region R2 may be larger than the area of the first region R1, and the area of the first region R1 may be larger than the area of the second region R2. If a material layer having high ionic conductivity at low temperature is formed to have a large area and is located adjacent to a side of the unit cell having a large area of low temperature, the temperature gradient difference may be further reduced. Therefore, non-uniform performance of a fuel cell caused by the temperature gradient difference may be made more uniform.

Hereinafter, improved performance of unit cells according to the embodiment of the present invention and a comparative example will be described with reference to Table 1.

### Example 1

In the Example 1 of the present invention, an anode support is employed.

Powder of rare-earth oxides (for example, Y₂O₃) excluding La, Ce, Pr, and Nd is mixed with powder of Ni and/or NiO to form a mixed powder. A mixture made by mixing an organic binder and a solvent with the mixed powder is extruded to form a support body, the extruded support body is dried and sintered at 1,250 degrees Celsius.

Next, an oxide powder containing powder of Ni and/or NiO and rare-earth elements such as Y₂O₃—ZrO₂ is mixed with an organic binder and a solvent to form a slurry. An anode layer is coated on the support body using the slurry.

After that, an electrolyte layer is coated on the support body coated with the anode layer using the manufactured slurry by mixing the oxide powder containing rare-earth elements such as Y₂O₃—ZrO₂ with an organic binder and a solvent, and the support body coated with the electrolyte layer is simultaneously (or concurrently) sintered under the oxygen containing mood at 1,300 degrees Celsius to 1,600 degrees Celsius.

Next, a paste is made by mixing a powder of transition metal Perovskite lanthanum strontium manganite (LSM) oxide with a solvent and is coated to the first region R1, the second region R2, and the third region R3. After that, the first region R1 is masked, a paste made by mixing powder of Perovskite lanthanum strontium cobalt ferrite (LSCF) oxide with a solvent is coated to the second region R2 and the third region R3, and is annealed at 1,000 degrees Celsius to 1,300 degrees Celsius so that a fuel cell according to the Example 1 of the present invention may be manufactured.

Test for performance enhancement of a unit cell was carried out and the test results are listed in the following Table 1.

As listed in Table 1, it is understood that, in comparison to the performance of a unit cell in which only the Perovskite LSM oxide layer is coated to the first region R1, the second region R2, and the third region R3, the performance of a unit cell in which Perovskite LSM/LSCF oxide combination electrode material layer is coated to the second region R2 and the third region R3 is improved when the unit cell is driven at low temperature.

### Comparative Example 1

A unit cell in which the Perovskite LSM/LSCF oxide combination electrode material layer is not coated to the second region R2 and the third region R3, as in the above Example 1, was produced as a comparative example. Comparative Example 1 is identical to the above Example 1 except that the Perovskite LSM/LSCF oxide combination electrode material layer was not formed on the second region R2 and the third region R3. Identically to the above Example 1, a performance test of the unit cell of Comparative Example 1 was carried out and the test results are listed in the following Table 1.

As listed in Table 1, it is understood that, in comparison to the performance of a unit cell in which only the Perovskite LSM/LSCF oxide combination electrode material layer is coated to the second region R2 and the third region R3, the performance of a unit cell in which only Perovskite LSM oxide layer is coated to the first region R1, the second region R2, and the third region R3 is inferior when the unit cell is driven at low temperature.

TABLE 1

| | Performance (%) | Performance (%) | Performance (%) |
|---|---|---|---|
| | of unit cell at | of unit cell at | of unit cell at |
| | 800° C. | 750° C. | 700° C. |
| Comparative | 100 | 68 | 38 |
| Example 1 | | | |
| Example 1 | 100 | 95 | 68 |

According to the present invention, a fuel cell module including a combination electrode having different ionic conductivities and a method of manufacturing the same may be provided.

A temperature gradient difference of a unit cell may be reduced to make performance of the unit cell more uniform so that durability of the fuel cell module may be improved.

In addition, a fuel cell module capable of being driven at low temperature and maintaining performance within a unit cell and a method of manufacturing the same may be provided.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A fuel cell module comprising a unit cell comprising a first electrode layer, an electrolyte layer and a second electrode layer, the first electrode layer, the electrolyte layer, and the second electrode layer being sequentially laminated with one another,
wherein at least one of the first electrode layer or the second electrode layer has a first region coated with a first electrode material layer having a first ionic conductivity, a second region coated with a second electrode material layer having a second ionic conductivity, and a third region coated with a third electrode material layer having a third ionic conductivity.

2. The fuel cell module as claimed in claim 1, wherein the second region is located adjacent to a side of the unit cell through which a fuel is injected, the third region is located adjacent to a side of the unit cell through which the fuel is discharged, and the first region is located between the second region and the third region.

3. The fuel cell module as claimed in claim 1, wherein, when the first region, the second region, and the third region have a same temperature, the second ionic conductivity and the third ionic conductivity are higher than the first ionic conductivity.

4. The fuel cell module as claimed in claim 1, wherein the second ionic conductivity is equal to the third ionic conductivity.

5. The fuel cell module as claimed in claim 1, wherein the second region has the same area as that of the third region.

6. The fuel cell module as claimed in claim 5, wherein an area ratio of the second region to the first region is 3:5 to 4:3.

7. The fuel cell module as claimed in claim 5, wherein the second region has the same area as that of the first region.

8. The fuel cell module as claimed in claim 1, wherein the first region, the second region, and the third region have different areas respectively.

9. The fuel cell module as claimed in claim 8, wherein the area of the third region is larger than that of the second region.

10. The fuel cell module as claimed in claim 8, wherein the area of the first region is larger than that of the second region.

11. The fuel cell module as claimed in claim 8, wherein the area of the second region is larger than that of the first region.

12. A method of manufacturing a fuel cell module, the method comprising:
sequentially laminating a first electrode layer, an electrolyte layer, and a second electrode layer; and
coating one of the first electrode layer or the second electrode layer to have a first region coated with a first electrode material layer having a first ionic conductivity, a second region coated with a second electrode material layer having a second ionic conductivity, and a third region coated with a third electrode material layer having a third ionic conductivity.

13. The method as claimed in claim 12, wherein the second region has a side at which a fuel is injected, the third region has a side at which the fuel is discharged, and the first region is between the second region and the third region.

14. The method as claimed in claim 12, wherein, when the first region, the second region, and the third region have a same temperature, the second ionic conductivity and the third ionic conductivity are higher than the first ionic conductivity.

15. The method as claimed in claim 12, wherein the second ionic conductivity is equal to the third ionic conductivity.

16. The method as claimed in claim 12, wherein the second region has the same area as that of the third region.

17. The method as claimed in claim 16, wherein an area ratio of the second region to the first region is 3:5 to 4:3.

18. The method as claimed in claim 16, wherein the second region has the same area as that of the first region.

19. The method as claimed in claim 12, wherein the first region, the second region, and the third region have different areas respectively.

20. The method as claimed in claim 19, wherein the area of the third region is larger than that of the second region.

21. The method as claimed in claim 19, wherein the area of the first region is larger than that of the second region.

22. The method as claimed in claim 19, wherein the area of the second region is larger than that of the first region.
